(19) United States
(12) Patent Application Publication
(10) Pub. No.: US 2006/0184461 A1
(43) Pub. Date: Aug. 17, 2006

(54) Clustering system

(75) Inventor: Atsushi Mori, Tokyo (JP)

Correspondence Address: Reed Smith LLP, Suite 1400, 3110 Fairview Park Drive, Falls Church, VA, 22042-4503, US

(73) Assignee: Hitachi Software Engineering Co., Ltd.

(21) Appl. No.: 11/269,852

(22) Filed: Nov. 9, 2005

(30) Foreign Application Priority Data
Dec. 8, 2004 (JP) 2004-355214

(51) Int. Cl. G06N 3/12

(52) U.S. Cl. 706/13

(57) ABSTRACT

A group of cells are newly clustered on the basis of the result of implementing a SOM. A plurality of pieces of multivariate data are clustered via a SOM, and cells are displayed on a two-dimensional plane as rectangular or hexagonal shapes. The level of similarity between representative vectors from each adjacent cell is calculated, and a dendrogram is three-dimensionally depicted. Cells on a SOM map are colored differently in accordance with a plane for partitioning the dendrogram.

### CLAIM OF PRIORITY

The present application claims priority from Japanese application JP 2004-355214 filed on Dec. 8, 2004, the content of which is hereby incorporated by reference into this application.

### BACKGROUND OF THE INVENTION

1. Field of the Invention

The present invention relates to a clustering system for displaying the results of clustering in a visually easily recognizable manner using a combination of clustering techniques involving a SOM (self-organizing map) and a dendrogram.

2. Background Art

Conventionally, the SOM (self-organizing map) (T. Kohonen, “Self-Organizing Maps,” Springer 1995) has been used as a clustering technique for grouping a plurality of items of multivariate data by calculating the similarity between them in terms of the Euclidean distance (simple geometric distance in a multidimensional space) or the Manhattan distance (distance expressed in terms of simple difference in each dimension). The SOM, which is one of non-hierarchical techniques, is a technique whereby data is mapped on a two-dimensional plane. The SOM produces a clustering result such that data with smaller distances (i.e., with greater similarities) is clustered on the two-dimensional plane. Another clustering technique that has been used for a long time involves the use of a dendrogram in which the similarity among individual pieces of data are displayed in a hierarchical manner, as disclosed in Patent Document 1. In a dendrogram, the distances among clusters are calculated according to a definition formula based on the Ward's method or the nearest neighbor method, for example, and clusters with smaller distances are displayed together in a dendrogram (tournament diagram). Because the results obtained from the dendrogram method do not provide any clue as to where the clusters can be optimally partitioned, calculation formulae have been devised that are based on standards such as, e.g., one by which clusters are partitioned such that the distance between data in each cluster becomes minimum and the distance between each cluster becomes maximum.

Meanwhile, data mining including a variety of clustering techniques, such as the SOM and dendrograms, is being used in recent years for discovering biologically significant information in data that has been comprehensively analyzed in gene expression analysis involving a DNA microarray. In this case, the data used in multivariate analysis such as clustering consists of values represented in terms of each gene as a key and the DNA array as a dimension, or, conversely, the DNA microarray as a key and each gene as a dimension. It has been reported in papers that, when each gene is taken as a key, groups of genes associated with metabolism or development are obtained as clusters in experiments involving time-series data. When the DNA microarray is used as a key, on the other hand, subtypes of diseases, such as cancer, are obtained as individual clusters. Thus, there are expectations that such data mining will be applied to clinical diagnostic techniques.

Patent Document 1: JP Patent Publication (Kokai) No. 2004-192651 A

Non-patent Document 1: T. Kohonen, “Self-Organizing Maps,” Springer 1995

Non-patent Document 2: J. Cybernetics. Vol. 4, 1974, pp. 95-104

Non-patent Document 3: IEEE Transactions on Pattern Analysis and Machine Intelligence, Vol. 1, No. 2, 1979, pp. 224-227

Non-patent Document 4: J. Comp App. Math, Vol. 20, 1987, pp. 53-65

### SUMMARY OF THE INVENTION

When the SOM is used as a clustering tool, data put together in each cell in the result of clustering forms a single cluster, and it can be visually recognizable that data in nearby cells are similar. However, it is difficult to visually determine which of the cells that are adjacent a particular cell is most similar to the particular cell. Further, the number of cells that is used in the initial setting of the SOM is often inappropriate from the viewpoint of the final clustering result. Thus, there is a need to visually display which groups of cells can be merged together based on verification using statistical analysis.

It is therefore an object of the invention to provide a technique whereby the structure of a clustering result obtained by the SOM can be visualized by calculating the degree of similarity among cells, so that the user of a clustering display system can newly cluster groups of cells based on the result of the SOM.

In order to achieve the aforementioned object, the invention provides a display system for three-dimensionally depicting a dendrogram on a SOM map by applying the dendrogram technique to the result of SOM clustering. Specifically, the system of the invention includes: means for entering a plurality of pieces of multivariate data; means for clustering the thus entered multivariate data by the SOM method and displaying cells on a two-dimensional plane as rectangular or hexagonal shapes; means for calculating the level of similarity between representative vectors of four adjacent cells in the case of rectangular cells or six adjacent cells in the case of hexagonal cells; means for depicting a dendrogram three-dimensionally based on the level of similarity; and means for displaying a plane for partitioning the dendrogram and allowing the user to change a partitioning position. The plane for partitioning the dendrogram may be automatically determined by a clustering result evaluation means.

In accordance with the invention, whereby the result of SOM clustering is processed using a dendrogram, which is an hierarchical clustering tool, it becomes possible to visually recognize the relative levels of similarity between cells or how the cells are grouped, in view of a three-dimensionally displayed dendrogram. By partitioning the three-dimensionally depicted dendrogram by a plane, the groups of cells can be re-clustered at a visually appropriate position. Furthermore, by applying a prior-art evaluation standard for determining an optimum partitioning position to the result of a dendrogram, the position for re-clustering the result of SOM clustering can be automatically determined.

### BRIEF DESCRIPTION OF THE DRAWINGS

FIG. 1 shows an example of the structure of a system according to the invention.

FIG. 2 shows an example of the result of implementing a SOM (cells are rectangular in shape).

FIG. 3 shows an example of the result of implementing a SOM (cells are hexagonal in shape).

FIG. 4 shows an example of the result of implementing a dendrogram.

FIG. 5 shows a three-dimensional depiction of a dendrogram (cells are rectangular in shape).

FIG. 6 shows an example in which the position for partitioning a dendrogram on a plane is determined by a line.

FIG. 7 schematically shows how an optimum number of clusters is determined from a clustering evaluation value.

FIG. 8 shows an example in which the dendrogram partitioning position is determined by a plane (where the shape of the cells is rectangular and the number of clusters is two).

FIG. 9 shows an example in which the dendrogram partitioning position is determined by a plane (where the shape of the cells is rectangular and the number of clusters is three).

FIG. 10 shows an overall flowchart.

FIG. 11 shows a flowchart of the process for determining the partitioning position.

### DESCRIPTION OF PREFERRED EMBODIMENTS

An embodiment of the invention will be hereafter described by referring to the drawings.

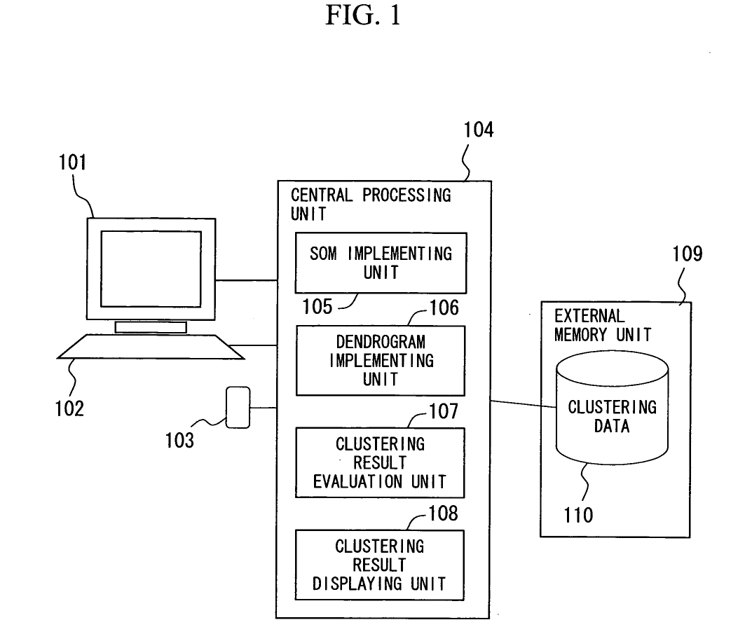

FIG. 1 shows the system structure of an embodiment of the invention. The system includes a central processing unit 104 for the calculation and evaluation for clustering as well as the display of their results, a display unit 101 having a character and graphic screen, a keyboard 102, mouse 103, and an external memory unit 109 for storing clustering data 110. The central processing unit 104 includes a SOM implementing unit 105, a dendrogram implementing unit 106, a clustering result evaluating unit 107, and a clustering result displaying unit 108. The SOM implementing unit 105, the dendrogram implementing unit 106, the clustering result evaluating unit 107, and the clustering result displaying unit 108 can all be realized using programs.

The SOM implementing unit 105 receives clustering data and algorithm setting parameters and then performs clustering by the SOM method. For the setting of parameters, the size of cells, the number of times of learning, a function indicating the degeneracy of the area of influence of a cell, and so on are used. Thus, the invention does not require the addition of any special algorithm. The difference in the number of adjacent cells, which would be dependent on whether the cells are rectangular or hexagonal in shape, and the method of display of a map are relevant to the present invention. The dendrogram implementing unit 106 performs clustering via a dendrogram using as parameters the selection of the formula for the calculation of distance/similarity and the selection of the algorithm for merging clusters. The method of the invention differs from known methods in that representative vectors of a SOM are only compared between adjacent cells.

The clustering result evaluating unit 107 is a module for evaluating the validity of a clustering result. It employs an algorithm for evaluating clustering results, such as Silhouette Index and, in the case of a dendrogram, determines an optimum cluster partitioning position within a range designated by the number of clusters. The clustering result displaying unit 108 performs processes for depicting a dendrogram on a SOM map and displaying a plane for partitioning a three-dimensionally displayed dendrogram, for example. The clustering result displaying unit 108 is therefore indispensable for achieving the advantageous effects of the invention.

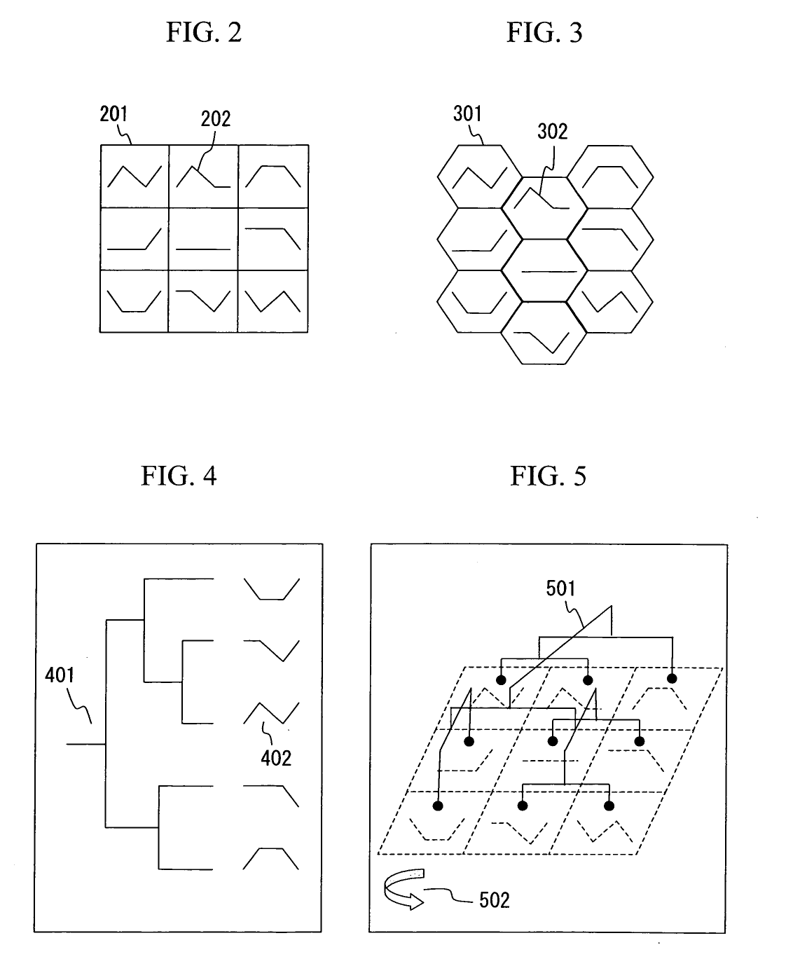

FIG. 2 conceptually shows results of implementing the SOM method using rectangular cells. Cell size is 3×3, and the multivariate data consists of quartic data. Numeral 201 designates rectangular cells including four, namely, top, bottom, left, and right, adjacent cells. The number of adjacent cells could be eight depending on the setting. Numeral 202 designates representative vectors determined by individual pieces of data allocated in each cell. The calculation method may involve an average value or a central value. For example, in a case of gene expression analysis using a DNA microarray, each gene would have vector data with an order that corresponds to the number of chips if clustering were to be performed in the direction of genes. Although in many cases gene expression analysis is performed using dozens of DNA microarrays, there are four chips in the example of FIG. 2. Therefore, if clustering were to be performed by the SOM method using time-series data consisting of cerebellar tissue samples of mice taken one day, two days, four days, and eight days after birth, for example, the data would be clustered into e.g. a group of genes that are always expressed in the cerebellum and a group of genes that are only expressed in the initial phases after birth when they are allocated in the cells. The cell at the center of FIG. 2 contains a group of genes that are not expressed at all times. This group of genes is used as a representative vector that is calculated by determining the median values of data from thousands of genes and that is be compared with other cells.

FIG. 3 schematically shows the result of implementing the SOM method using hexagonal cells. As in FIG. 2, cell size is 3×3 and the multivariate data consists of quartic data. Numeral 301 designates hexagonal cells that include six adjacent cells. Numeral 302 designates a representative vector determined from the data allocated in each cell, as in the cell 202.

FIG. 4 conceptually shows a conventional dendrogram obtained using an algorithm such that vector data are merged in order of decreasing levels of similarity. In the dendrogram designated by numeral 401, the horizontal axis shows the distance indicating the level of similarity between individual pieces of data. Numeral 402 designates individual pieces of vector data, of which similar data are disposed close to one another.

FIG. 5 conceptually shows a three-dimensional dendrogram based on the result of clustering obtained by the SOM method shown in FIG. 2. Numeral 501 designates the results of merging data that is similar in terms of the representative vectors in each cell, where the distances between data are represented in terms of height, as in the conventional dendrogram rendered on a two-dimensional plane. As opposed to the conventional dendrogram, cells that can be merged are only those that are adjacent to one another. Numeral 502 designates an arrow indicating the fact that the three-dimensional dendrogram can be rotated by a mouse operation or a menu operation, for example. Such a three-dimensional rotating display of a dendrogram can be realized by means of a conventional technique.

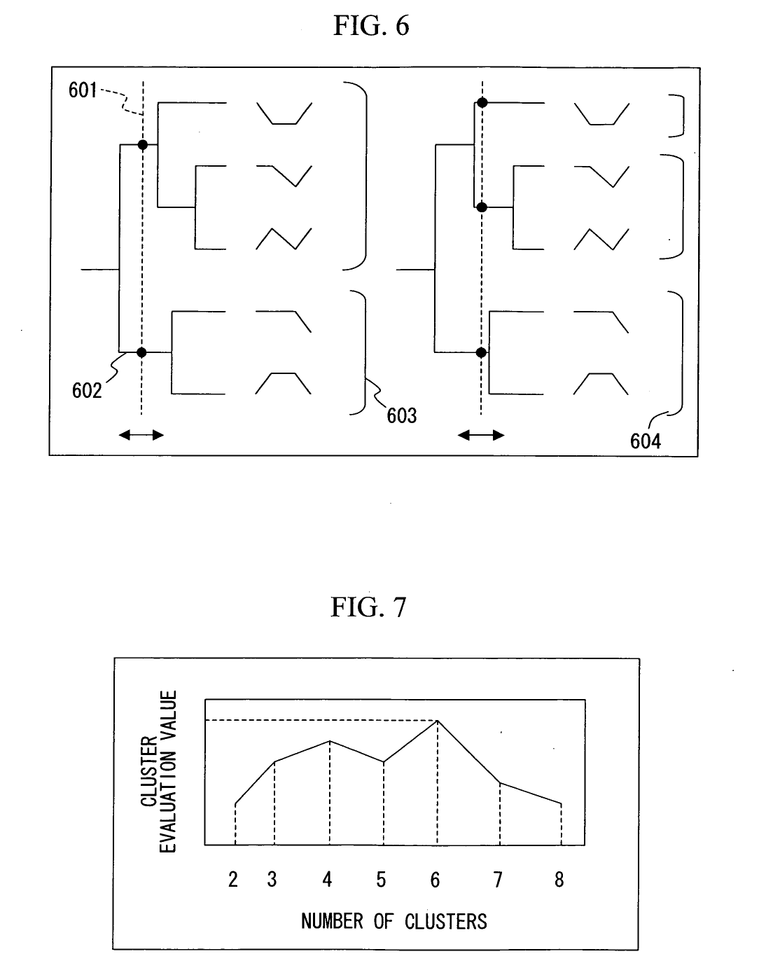

FIG. 6 conceptually shows how a dendrogram obtained by implementing the dendrogram method is partitioned so as to determine clusters. Numeral 601 designates a broken line that indicates the position at which the dendrogram is partitioned. Numeral 602 designates a dot that indicates the position at which the dendrogram intersects the broken line. Numeral 603 conceptually designates individual clusters each representing the data in the trees to the right of the dot. By changing the partitioning position by moving the broken line 601 towards the right, the number of clusters that can be obtained can be changed.

FIG. 7 conceptually shows a process of determining, using a variety of algorithms for calculating the validity of clustering results, an optimum number of clusters by calculating a cluster evaluation value in clusters that are obtained by moving the partitioning line of a dendrogram, for example. As mentioned above with reference to background art, algorithms that have been developed for calculating the validity of a clustering result perform calculations in accordance with a standard such as, e.g., one by which clusters are deemed optimum when they have a minimum distance between data in each cluster and when the distance between each cluster is maximum. Examples of such a reference that has so far been proposed include the Dunn's Index disclosed in Non-patent Document 2, the Davies Bouldin Index disclosed in Non-patent Document 3, and the Silhouettes Index disclosed in Non-patent Document 4. The user selects a particular index, and then calculates cluster evaluation values for two clusters that are determined at a partitioning position such that the number of clusters to the left shown in FIG. 6 is two. The user then calculates the cluster evaluation value for a case where there are three clusters to the right in FIG. 6. In a similar manner, the user calculates the cluster evaluation values in order within a range of the number of clusters determined by the user, whereby an optimum cluster number (6 in the example of FIG. 7) is determined.

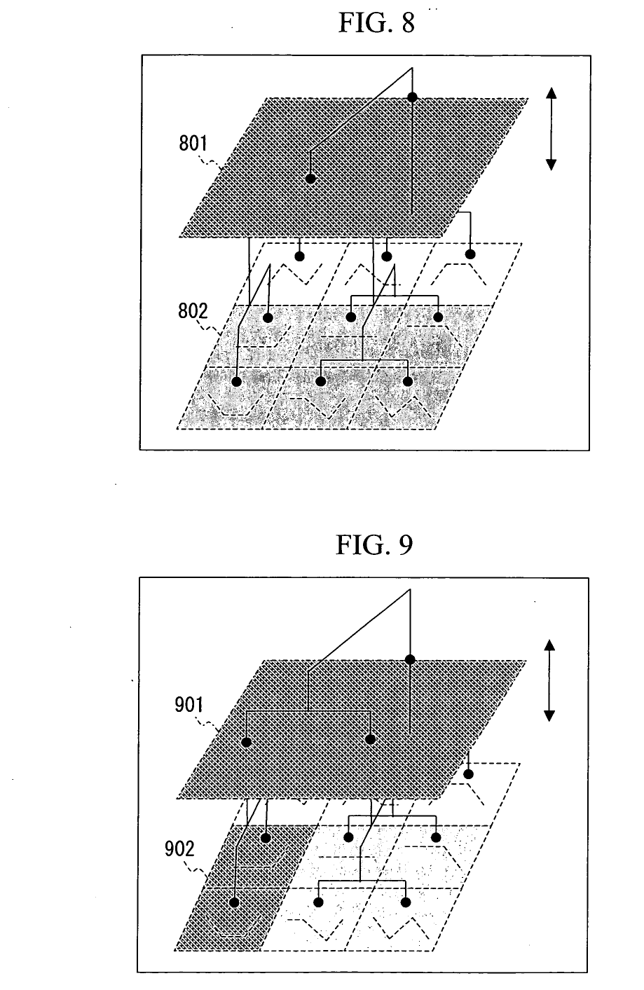

FIGS. 8 and 9 show how the cluster partitioning position for partitioning a dendrogram that is drawn as shown in FIG. 5 is determined in a plane in a manner similar to how the cluster partitioning position is generally determined in a two-dimensional dendrogram using a line as shown in FIG. 6.

With reference to FIG. 8, numeral 801 designates a plane by which the dendrogram is partitioned. The units above the SOM that are located below the points of intersection of the partitioning plane and the dendrogram form clusters. The method of determining the partitioning position includes a method whereby the partitioning position is visually determined by moving up and down the partitioning plane 801 using a GUI, and a method whereby the partitioning position is determined automatically using cluster evaluation values as shown in FIG. 7.

Numeral 802 designates cells that have been colored differently so as to distinguish clusters depending on the position partitioned by the plane. In the example shown in FIG. 8, the cells are re-clustered into two regions on the SOM map. FIG. 9 shows another example where the partitioning plane 901 has been moved another step downward as compared with the example of FIG. 8. In this example, the cells are colored into three different regions on the SOM map, as indicated by numeral 902.

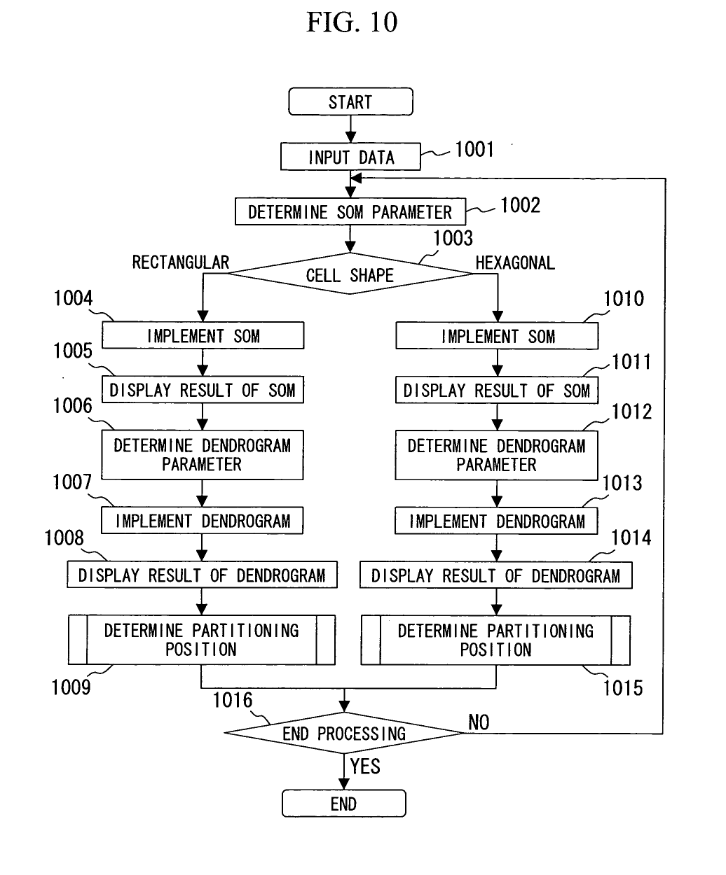

FIG. 10 shows a flowchart of the entire process according to the invention.

Numeral 1001 designates a step for entering clustering data.

Numeral 1002 designates a step for entering and determining parameters, such as the number of cells, as mentioned above.

Numeral 1003 designates a branching step for branching the routine into different processes for the parameter determined in process 1002 depending on the difference in the shape of the cells.

Numeral 1004 designates a step for implementing the SOM method using the parameters determined in step 1002.

Numeral 1005 designates a step for rendering the result of step 1004 in a two-dimensional plane.

Numeral 1006 designates a step for selecting the method of calculation of the level of similarity and for selecting a cluster-merging algorithm for use in the dendrogram method.

Numeral 1007 designates a step for implementing the dendrogram method, whereby a minimum value of the distance between representative vectors is determined from the adjacent cells in a rectangular cell (including a polygonal cell after merger), where the determination is made for all the cells (using a merging algorithm during merger), and whereby clusters with minimum distances are merged repeatedly. Because distances are calculated only for those clusters that are adjacent on the SOM plane, the volume of calculation required can be reduced as compared with that required by the conventional dendrogram method.

Numeral 1008 designates a step for displaying the result of the dendrogram method three dimensionally. The step 1008 includes, as in general clustering systems, a process for displaying the distance between clusters in a pop-up upon selecting of a particular branch, and a process for displaying the height of branches in logarithms. The dendrogram can also be rotated so as to help identify the state of distribution of each cluster, thereby facilitating the finding of new insight.

Numeral 1009 designates a step for determining the partitioning position, of which details will be described later.

Numeral 1010 designates a step for implementing the SOM method using a hexagonal cell shape and the parameter determined at step 1002.

Numeral 1011 designates a step for rendering the result of step 1010 in a two-dimensional plane, as shown in FIG. 3.

Numeral 1012 designates a step for selecting the method of calculation of similarity and a cluster merging algorithm for implementing the dendrogram method.

Numeral 1013 designates a step for merging clusters as at step 1007, the difference being that due to the hexagonal shape of the cells, the adjacent cells are determined in a different fashion from that of step 1007.

Numeral 1014 designates a step for displaying the result of the dendrogram process as at step 1008, with the difference being that, due to the hexagonal shape of the cells, the rendering process is performed in a slightly different fashion from that at step 1008.

Numeral 1015 designates a step for determining the partitioning position as at step 1009, of which details will be described later.

Numeral 1016 designates a step for ending the routine, from which the mining process of FIG. 10 is carried out again if any change is to be made regarding pre-processing or parameters in view of the result of clustering.

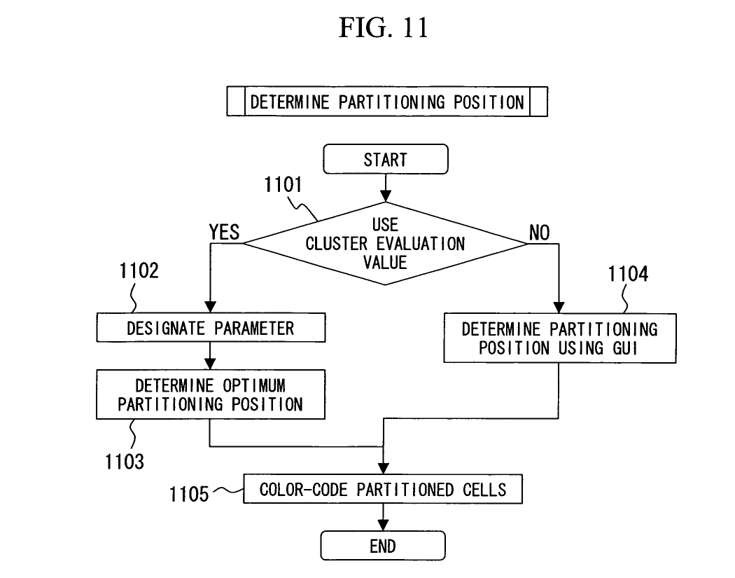

FIG. 11 shows a process for determining the partitioning position, which is made either automatically based on the method of evaluating the clustering result, or visually using a GUI.

Numeral 1101 designates a branching condition for selecting whether or not the user employs a clustering evaluation technique.

Numeral 1102 designates a step for selecting the range of the number of clusters and an algorithm for the calculation for evaluation.

At step 1103, the cluster evaluation value is calculated within the range of the number of clusters designated at step 1102, and, once an optimum cluster number is determined, a plane for partitioning the dendrogram is automatically moved to the position of the optimum cluster number.

Numeral 1104 designates a step for determining the partitioning position using a GUI, whereby the plane for partitioning the dendrogram can be dynamically moved by designating the number of clusters or through the operation of a mouse.

Numeral 1105 designates a step for differently coloring the cells partitioned by the dendrogram partitioning plane.

What is claimed is:

1. A clustering system comprising:
a SOM implementing unit for clustering a plurality of pieces of multivariate data on a two-dimensional plane;
a dendrogram implementing unit for clustering each of the cells in a SOM hierarchically using the similarity of representative vectors of adjacent cells; and
a clustering result displaying unit for three-dimensionally rendering the dendrogram obtained by said dendrogram implementing unit on the SOM obtained by said SOM implementing unit.

2. The clustering system according to claim 1, wherein said cells are rectangular or hexagonal in shape.

3. The clustering system according to claim 1, wherein said clustering result displaying unit displays the three-dimensionally rendered SOM and dendrogram in a rotating fashion.

4. The clustering system according to claim 1, further comprising an input means, wherein said clustering result displaying unit displays a plane for partitioning said three-dimensionally rendered dendrogram at a position designated through said input means.

5. The clustering system according to claim 1, further comprising a clustering result evaluating unit for determining the position for partitioning the dendrogram, wherein said clustering result displaying unit displays a plane for partitioning said three-dimensionally rendered dendrogram at a position determined by said clustering result evaluating unit.

6. The clustering system according to claim 4, wherein said clustering result displaying unit displays the cells on the SOM map, which have been partitioned as a result of the partitioning of said dendrogram, in different colors.

7. The clustering system according to claim 1, wherein said multivariate data consists of gene or protein expression data that is comprised of values represented in terms of each gene or protein as a key and samples as dimensions, or, conversely, samples as keys and each gene or protein as a dimension.
